(19) United States
(12) Patent Application Publication
(10) Pub. No.: US 2003/0155309 A1
(43) Pub. Date: Aug. 21, 2003

(54) Process and system for the self-regulated remediation of groundwater

(76) Inventor: A. Russell Schindler, Traverse City, MI (US)

Correspondence Address: ARTZ & ARTZ, P.C., 28333 TELEGRAPH RD., SUITE 250, SOUTHFIELD, MI, 48034, US

(21) Appl. No.: 10/366,966

(22) Filed: Feb. 14, 2003

Related U.S. Application Data
(60) Provisional application No. 60/357,550, filed on Feb. 15, 2002.

(51) Int. Cl. C02F 1/72

(52) U.S. Cl. 210/747; 210/759; 210/170

(57) ABSTRACT

A process and system for the self-regulated remediation of groundwater situated beneath the surface of a contaminated ground site is herein proposed. The process includes the steps of selecting a ground site to be tested for potential contamination, extracting soil gas samples from interspersed locations within an underground soil layer, gleaning information from the extracted soil gas samples to both determine the extent of any contamination and delimit any specific area of contamination at the selected ground site, determining both an appropriate concentration of a preselected oxidant or oxygen-releasing agent within a solution and an appropriate flow rate of injection according to the determined extent of contamination, determining both an appropriate number of groundwater injection points and an appropriate spacing between the groundwater injection points according to the delimited specific area of contamination, and delivering the determined preselected oxidant solution under pressure into the groundwater within the delimited specific area of contamination via the groundwater injection points at the determined injection flow rate.

### CROSS-REFERENCE TO RELATED APPLICATION

The present invention claims priority from United States Provisional Application Serial No. 60/357,550 entitled “Per-petual System” which was filed on Feb. 15, 2002.

### FIELD OF THE INVENTION

The present invention generally relates to a method and system for the remediation of groundwater situated beneath the surface of a contaminated ground site. The present invention more particularly relates to the utilization of both chemical oxidation remediation and bioremediation techniques for reducing the level of contamination within a subterranean body of groundwater.

### BACKGROUND OF THE INVENTION

Very nearly all organic compounds contain hydrogen, and they can be regarded as being derived from the very large number of compounds that contain carbon and hydrogen only, “the hydrocarbons,” by replacing hydrogen atoms by other atoms or groups of atoms. Modern civilization is almost totally dependent on hydrocarbons, which occur in the earth's crust as natural gas and petroleum. Natural gas, gasoline, diesel fuel, domestic heating oil, and industrial fuel oil, all of which are mixtures of hydrocarbons obtained by the distillation of petroleum, provide our major source of energy. Hydrocarbons are also the starting materials for the synthesis of a wide variety of organic compounds, ranging from drugs to plastics.

In light of such, groundwater contamination is becoming a problem of increasing concern within the minds of the modem, environmentally-conscious public. Such groundwater contamination is commonly the result of inadvertent spills from damaged or aging petroleum storage tanks. It is also commonly the result of either accidental discharges or intentional dumpings of liquid hydrocarbons, or other compositions containing the same, near industrial work sites. Such groundwater contamination, however, is not solely relegated to industrial complexes, for such contamination is also present in suburban neighborhood settings. Within such suburban settings, primary sources of any significant groundwater contamination are typically automobile service station sites. Such service station sites, especially if “out of business” and abandoned, frequently have antiquated and structurally unsound storage tanks, both above and below ground, that leak gasoline, fuel oils, lubricants, and the like into the ground. Ultimately, these fluid substances seep deep into the ground and find their way into local groundwater. In addition to automobile service station sites, dry cleaning business sites are also sometimes primary sources of significant groundwater contamination within suburban neighborhood settings, for dry cleaning businesses heavily utilize the noxious material tetrachloroethane in the dry cleaning process.

As a remedy, various remediation techniques have been developed and utilized in recent years for treating contaminated groundwater in order to substantially reduce or altogether eliminate the contaminants therein. One of the most widely used techniques has been the so-called “pump-and-treat remediation technique.” In this technique, a chemical solution including an aqueous surfactant is applied to the soil of a contaminated ground site. Once in the soil, the chemical solution leaches or percolates down through the soil, thereby passing through any specific areas of contamination within the soil until ultimately reaching the groundwater at the water table far beneath the surface of the contaminated ground site. The resulting leachate and contaminated groundwater is thereafter collectively pumped, via a ground-installed recovery well, up through the soil to the surface of the ground site. At this point, both the leachate and the displaced groundwater are treated at an above-ground treatment facility commonly situated on a truck. Through treating both the leachate and the groundwater, contaminants are ultimately separated out from the groundwater. Thereafter, the treated groundwater is returned back underground, and the separated-out contaminants are disposed of in an environmentally safe manner. In sum, although the pump-and-treat technique is reasonably effective in successfully treating contaminated groundwater, the technique undesirably requires heavy machinery to both pump and treat contaminated groundwater above ground, undesirably requires significant active human involvement or supervision during operation and for maintenance, and is very expensive.

A second technique that has been developed and utilized in recent years for treating contaminated groundwater is the “chemical oxidation remediation technique.” In this technique, contaminant hydrocarbons or other organic compounds are basically oxidized by means of ordinary chemical reactions to yield harmless end products, namely carbon dioxide and water. More particularly, in this technique, an oxidant is injected at varying concentrations into the aquifer far below the surface of a contaminated ground site. Due to the fact that there is typically little to no oxidant originally residing within the pores of such deep soil having a low permeability characteristic, there is a strong natural force (a concentration gradient) that drives the injected oxidant to diffuse down into these deep soil pores where contaminants are apt to be sequestered. In this way, contaminants situated in the deep soil aquifer below the surface of a contaminated ground site are successfully reached and oxidized. In sum, although the chemical oxidation technique is reasonably effective in successfully treating contaminated groundwater, the technique to date has only seen infrequent use. Such is due primarily to the fact that current versions of the technique generally require the injection of large amounts of necessary chemicals that typically give rise to problems associated with groundwater hydrology.

A third technique that has been developed and utilized in more recent years for treating contaminated groundwater is the “bioremediation technique.” In this technique, naturally occurring bacteria already living within the soil and/or non-indigenous bacteria artificially injected into the soil are utilized to feed on and altogether consume contaminants within the soil and groundwater of a contaminated ground site. Given that bacteria are similar to humans in that they are living organisms that require basic life-sustaining conditions to survive, they too therefore require oxygen to live and thrive. In light of such, it has been demonstrated that artificially increasing the concentrations of dissolved oxygen in petroleum-impacted groundwater is effective in increasing local bacteria populations, thereby facilitating the consumption and clean-up of aerobically biodegradable petroleum constituents. The type of bacteria required for such biodegradation naturally occurs in nearly every subsurface soil environment. Such bacteria utilize any petroleum-based contaminants that they encounter within the deep soil aquifer as a source of food for living.

What most contaminated groundwater aquifers lack, however, is a supply of oxygen that is sufficient to enable bacteria existing within the soil to thrive in numbers sufficient to successfully biodegrade contaminants in a timely manner. To remedy such an inadequate supply of oxygen, it has been particularly demonstrated that injecting ambient air into the groundwater at a contaminated ground site will produce a dissolved oxygen concentration of up to 10 to 12 parts per million (ppm). Such a slight artificial increase in dissolved oxygen concentration as compared to naturally occurring dissolved oxygen concentrations, however, is generally not sufficient enough to adequately increase a local bacteria population for the effective biodegradation of local contaminants. Given such, it has been alternatively demonstrated that injecting pure oxygen into the groundwater will produce a dissolved oxygen concentration of up to 35 to 40 ppm.

Although such is an improvement, ways to still further increase dissolved oxygen concentrations have been sought. In particular, various attempts to increase dissolved oxygen concentrations by utilizing oxygen-releasing compounds, for example, magnesium peroxide or calcium peroxide, have been undertaken. These oxygen-releasing compounds, however, also produce only modest increases in dissolved oxygen concentrations and are undesirably much more expensive to utilize than the aforementioned ambient air and pure oxygen.

In sum, although the bioremediation technique is somewhat effective in successfully treating contaminated groundwater, current versions of the technique have much room for needed improvement with regard to successfully increasing dissolved oxygen concentrations within underground soil. Such improvement is particularly needed in regard to “tight soil” conditions wherein, for example, one or more certain types of clay are present. In addition, many current versions of the technique have also been relatively impractical due to the expense and complexity of their procedures and the necessary equipment involved such as, for example, expensive and complex reactors. Even further, some current versions of the technique are prone to cause adverse geochemical reactions by undesirably introducing new toxic compounds into the groundwater. Lastly, many current versions of the bioremediation technique still require the utilization of non-organic catalysts or additives to facilitate faster completion of the biodegradation process within a reasonable period of time. Such catalysts or additives often give rise to additional issues of contamination within the groundwater.

In light of the above, there is a present need in the art for a groundwater remediation process and/or system that (1) successfully treats contaminated groundwater while underground, (2) significantly increases dissolved oxygen concentrations within contaminated groundwater, even under tight soil conditions, (3) requires minimal human supervision during operation, (4) requires no electricity or electrical equipment for successful operation, (5) requires no mechanical parts that are prone to breaking or requiring unintended maintenance, (6) causes minimal site disruption and does not interfere with underground utilities in suburban settings, and (7) is relatively inexpensive.

### SUMMARY OF THE INVENTION

The present invention provides a process for the self-regulated remediation of groundwater situated beneath the surface of a contaminated ground site. According to the present invention, the process basically includes, first of all, the step of selecting a ground site to be tested for potential contamination. Thereafter, the process basically includes the step of extracting soil gas samples from interspersed locations within an underground soil layer that is disposed immediately above the surface level of groundwater situated beneath the surface of the selected ground site. In a preferred process according to the present invention, the underground soil layer from which the soil gas samples are extracted is within the vadose zone, and the surface level of the groundwater actually coincides with the water table beneath the selected ground site. In addition, the process also basically includes the steps of gleaning information from the extracted soil gas samples to both determine the extent of any contamination and delimit any specific area of contamination at the selected ground site, determining both an appropriate concentration of a preselected oxidant or oxygen-releasing agent within a solution and an appropriate flow rate of injection according to the determined extent of contamination, and determining both an appropriate number of groundwater injection points and an appropriate spacing between the groundwater injection points according to the delimited specific area of contamination. In a preferred process according to the present invention, the preselected oxidant or oxygen-releasing agent is hydrogen peroxide due to its favorable characteristic of being able to help produce high concentrations of dissolved oxygen underground, even in tight soil conditions. Furthermore, the process also basically includes the step of delivering the determined preselected oxidant solution under pressure into the groundwater within the delimited specific area of contamination at the selected ground site. This basic step of delivering the determined preselected oxidant under pressure into the groundwater is particularly carried out via the groundwater injection points at the determined injection flow rate.

In a preferred process according to the present invention, the basic step of extracting soil gas samples itself includes, first of all, the step of installing a plurality of monitoring wells at the selected ground site such that each monitoring well provides fluid communication between the surface of the selected ground site, the underground soil layer, and the groundwater. In addition, the basic step of extracting soil gas samples also preferably includes the steps of providing a vacuum pump for each monitoring well at the selected ground site and thereafter utilizing each vacuum pump to create a vacuum within each monitoring well. In this manner, soil gas samples are thereby successfully drawn and obtained from the interspersed locations within the underground soil layer beneath the surface of the selected ground site.

Also, in a preferred process according to the present invention, the basic step of gleaning information from the extracted soil gas samples is accomplished with a soil gas meter. This information specifically gleaned from the extracted soil gas samples via the soil gas meter includes both the concentration of oxygen and the concentration of carbon dioxide within the underground soil layer. Given such information, the self-regulated groundwater remediation process according to the present invention preferably further includes the step of specifically regulating both the delivery pressure and the determined injection flow rate of the determined preselected oxidant solution to thereby specifically maintain the oxygen concentration within a range of 15 to 25 percent within the underground soil layer within the delimited specific area of contamination at the selected ground site. In doing such, optimal performance of the overall process is significantly facilitated.

Additionally, in a preferred process according to the present invention, the self-regulated groundwater remediation process further includes the steps of extracting soil samples from the selected ground site, extracting water samples from the groundwater situated beneath the surface of the selected ground site, and gleaning additional information from both the extracted soil samples and the extracted water samples to both further help determine the extent of any contamination and further help delimit any specific area of contamination at the selected ground site. This additional information specifically gleaned from both the extracted soil samples and the extracted water samples includes the detected presence, the species identification, and the population size of any microbial population present at the selected ground site.

Furthermore, in a preferred process according to the present invention, the self-regulated groundwater remediation process further includes the step of arranging the groundwater injection points in a substantially horizontal and grid-like fashion within the groundwater within the delimited specific area of contamination at the selected ground site. Also, in a preferred process according to the present invention, the self-regulated groundwater remediation process further includes the step of utilizing a known local groundwater flow rate determined over a recent two-month period to determine the appropriate spacing between the groundwater injection points within the groundwater within the delimited specific area of contamination at the selected ground site. In doing both of such, optimal performance of the overall process is further significantly facilitated.

To successfully implement the process described hereinabove, the present invention also provides a system for the self-regulated remediation of groundwater situated beneath the surface of a contaminated ground site. According to the present invention, the system basically includes, first of all, a plurality of monitoring wells installed interspersedly at a selected ground site to be tested for potential contamination. Each monitoring well is particularly installed such that it thereby provides fluid communication between the surface of the selected ground site, groundwater situated beneath the surface of the selected ground site, and an underground soil layer disposed immediately above the surface level of the groundwater. In addition, the system also basically includes a matching plurality of vacuum pumps as well as a matching plurality of soil gas meters. Both the vacuum pumps and the soil gas meters are situated at the selected ground site such that both are in fluid communication with the surface openings of the monitoring wells. Furthermore, the system also basically includes a first tank for containing a substantially inert gas under pressure, a second tank for containing a preselected oxidant or oxygen-releasing agent, and a pressure regulator. In a preferred embodiment of the present invention, the substantially inert gas within the first tank is, for example, either air or nitrogen, and the preselected oxidant or oxygen-releasing agent within the second tank is hydrogen peroxide. The pressure regulator is generally interposed between the first tank and the second tank for providing pressure-regulated fluid communication between the first tank and the second tank. Lastly, the system also basically includes a multiplicity of groundwater injection points in fluid communication with the second tank. These groundwater injection points are particularly spaced apart within the groundwater within a delimited specific area of contamination at the selected ground site.

Advantages, design considerations, and applications of the present invention will become apparent to those skilled in the art when the detailed description of the best modes contemplated for practicing the invention, as set forth hereinbelow, is read in conjunction with the accompanying drawings.

### BRIEF DESCRIPTION OF THE DRAWINGS

The present invention will be described, by way of example, with reference to the following drawings.

FIG. 1 is a partial cut-away side view of one embodiment of a self-regulated groundwater remediation system according to the present invention, wherein the extraction of soil gas samples from an underground soil layer via monitoring wells is particularly highlighted.

FIG. 2 is a partial cut-away side view of the FIG. 1 embodiment of a self-regulated groundwater remediation system according to the present invention, wherein the injection of a determined preselected oxidant solution into contaminated groundwater via groundwater injection points is particularly highlighted.

FIG. 3 is a top view of the FIGS. 1 and 2 embodiment of a self-regulated groundwater remediation system according to the present invention, wherein the locations of both monitoring wells and groundwater injection points at a selected convenient store and gas station site are particularly highlighted.

FIG. 4 is a partial cut-away side view of another embodiment of a self-regulated groundwater remediation system according to the present invention, wherein the injection of a determined preselected oxidant solution into the contaminated groundwater via three groundwater injection points is particularly highlighted.

FIG. 5 is a decoupled side view of the three groundwater injection points highlighted in FIG. 4, wherein the three groundwater injection points are separated for explanatory purposes.

FIG. 6 is a partial cut-away side view of the FIG. 4 embodiment of a self-regulated groundwater remediation system according to the present invention, wherein the injection of a determined preselected oxidant solution into the contaminated groundwater at a selected gas station site is particularly highlighted.

FIG. 7 is a close-up side view of the groundwater injection point encircled in FIG. 6, wherein the screen portion of the injection point is particularly highlighted.

FIG. 8 is a top view of the FIGS. 4 and 6 embodiment of a self-regulated groundwater remediation system according to the present invention, wherein the locations of both monitoring wells and groundwater injection points at the selected gas station site are particularly highlighted.

### DETAILED DESCRIPTION OF THE PREFERRED EMBODIMENTS

The present invention provides a process for the self-regulated remediation of groundwater situated beneath the surface of a contaminated ground site. The process, when implemented, successfully treats contaminated groundwater while underground, significantly increases dissolved oxygen concentrations within contaminated groundwater, even under tight soil conditions, and requires minimal human supervision during operation. To implement the process, the present invention also provides a system for the self-regulated remediation of groundwater situated beneath the surface of a contaminated ground site. The system, when implemented, requires no electricity or electrical equipment for successful operation, requires no mechanical parts that are prone to breaking or requiring unintended maintenance, causes only minimal site disruption and does not interfere with underground utilities in suburban settings, and is relatively inexpensive.

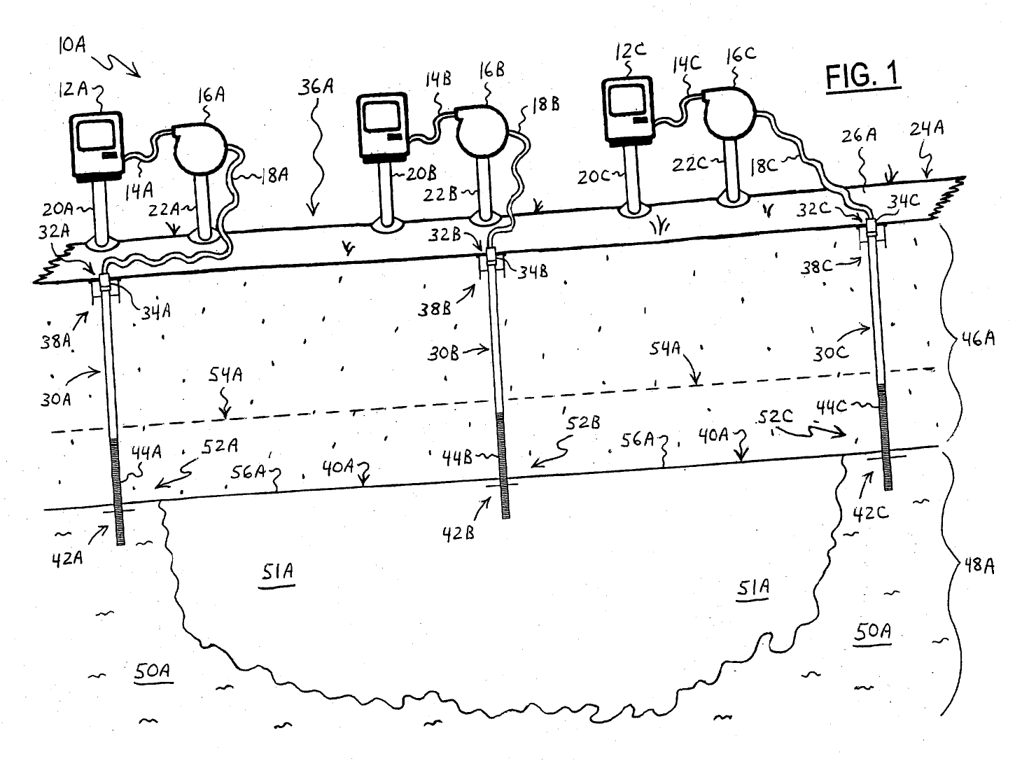

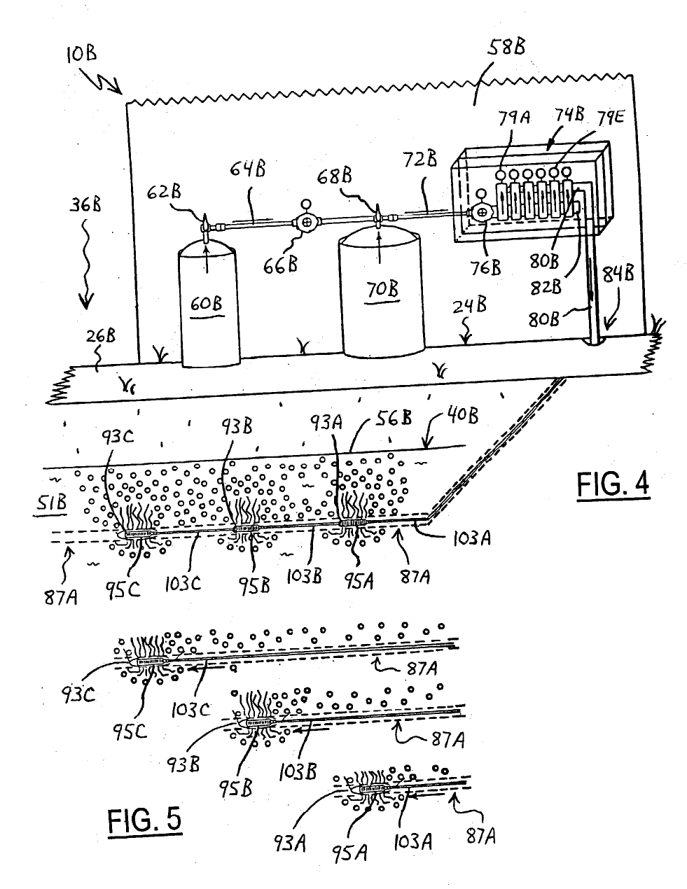

Both the preferred structures and the preferred operations of embodiments of the present invention are described in detail hereinbelow. In general, FIGS. 1 through 3 specifically relate to one embodiment of the present invention, and FIGS. 4 through 8 specifically relate to another embodiment of the present invention.

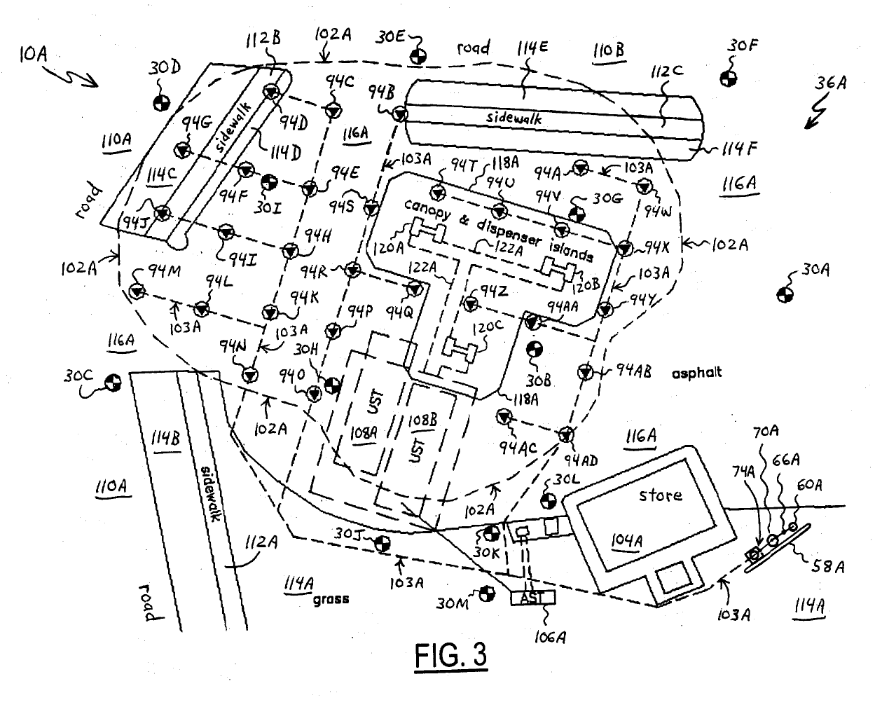

In FIG. 1, one embodiment of a system 10A for the self-regulated remediation of contaminated groundwater 51A situated beneath the surface 26A of a selected ground site 36A is illustrated. The ground site 36A, in this embodiment, is particularly a convenience store and gas station site (see FIG. 3). The ground site 36A has been selected in order to be tested for potential contamination. It is to be understood, however, that a system according to the present invention may alternatively be implemented at any other selected site that is suspected of having any contamination.

In FIG. 1, a plurality of monitoring wells 30A, 30B, and 30C have been interspersedly installed at the selected ground site 36A for the specific purpose of extracting soil gas samples. To accomplish such, each of the monitoring wells 30A, 30B, and 30C is particularly installed such that fluid communication is provided between the surface 26A of the selected ground site 36A, an underground soil layer 54A, and groundwater, whether the groundwater be contaminated groundwater 51A or uncontaminated groundwater 50A located within the aquifer 48A. The monitoring well 30A, for example, has, first of all, an upper end portion 38A that defines a surface opening 32A within the ground 24A. In addition, the monitoring well 30A also has a lower end portion 42A that intersects the groundwater surface level 56A which coincides with the water table 40A. The monitoring well 30A itself is preferably formed from galvanized pipe, or the like, and has a screen portion 44A that permits both soil gas and groundwater to communicate with the inside of the monitoring well 30A. The monitoring well 30A may, for example, have a diameter of 1 inch, and the screen portion 44A of the monitoring well 30A may, for example, have a length of 12 inches. The monitoring wells 30B and 30C are both similarly situated and constructed. It is to be understood, however, that the specific configuration, materials, and dimensions of a given monitoring well at a particular site may indeed vary as necessary.

After the monitoring wells 30A, 30B, and 30C have been interspersedly installed at the selected ground site 36A as illustrated in FIG. 1, both a matching plurality of vacuum pumps 16A, 16B, and 16C and a matching plurality of soil gas meters 12A, 12B, and 12C are provided at the selected ground site 36A. With regard to the monitoring well 30A, for example, the vacuum pump 16A is connected to the upper end portion 38A of the monitoring well 30A at the surface opening 32A in an airtight fashion via a well cap 34A and a vacuum hose 18A. The vacuum pump 16A, in turn, is connected to the soil gas meter 12A in an airtight fashion via a meter hose 14A. The vacuum pump 16A itself is mounted on the ground 24A at the selected ground site 36A by a mounting means 22A, wherein the mounting means 22A may be any known mounting means, including possibly a truck. Similarly, the soil gas meter 12A itself is also mounted on the ground 24A at the selected ground site 36A by a mounting means 20A, wherein the mounting means 20A may be any known mounting means, also including possibly a truck. In such a configuration, both the vacuum pump 16A and the soil gas meter 12A are then in fluid communication with the surface opening 32A of the monitoring well 30A. Both the soil gas meters 12B and 12C and the vacuum pumps 16B and 16C are similarly connected to the monitoring wells 30B and 30C.

Once both the vacuum pumps 16A, 16B, and 16C and the soil gas meters 12A, 12B, and 12C have been properly connected to the monitoring wells 30A, 30B, and 30C, soil gas samples from the underground soil layer 54A are then extracted. More particularly, the vacuum pumps 16A, 16B, and 16C are utilized to create vacuums within the monitoring wells 30A, 30B, and 30C to thereby draw and obtain soil gas samples from interspersed locations 52A, 52B, and 52C within the underground soil layer 54A located within the vadose zone 46A. As the soil gas samples are extracted in this manner, information is then gleaned from the extracted soil gas samples to, first of all, determine the extent of any contamination at the selected ground site 36A and, second, delimit any specific area of contamination at the selected ground site 36A. Gleaning the information from the soil gas samples is particularly accomplished with the soil gas meters 12A, 12B, and 12C. The information specifically gleaned includes both the oxygen concentration levels and the carbon dioxide concentration levels present at the interspersed locations 52A, 52B, and 52C within the underground soil layer 54A.

In general, to determine the extent of any contamination and delimit any specific area of contamination at a selected ground site, both the oxygen concentration levels and the carbon dioxide concentration levels of the soil gas samples are closely examined. If, for example, a particular soil gas sample extracted from a first underground location has an elevated carbon dioxide concentration level and a depleted (or nearly depleted) oxygen concentration level, it can then be generally assumed that the underground soil and groundwater location from which the soil gas sample was extracted is contaminated. Such an assumption can be made due to the fact that a depleted oxygen concentration level and a high carbon dioxide concentration level is typically a strong indication that underground bacteria thriving on both oxygen and contamination are producing an increased concentration level of carbon dioxide within the soil. If, on the other hand, a particular soil gas sample extracted from a second underground location has a lower carbon dioxide concentration level and a higher oxygen concentration level, it can then be generally assumed that the underground soil and groundwater location from which the soil gas sample was extracted is less contaminated or not contaminated at all. Thus, in sum, by extracting and comparing soil gas examples in this manner from interspersed locations within an underground soil layer, the extent of any contamination and the specific area of any contamination at a selected ground site can thereby be determined. One must be careful, however, to compare soil gas samples from interspersed locations within similar soil types and under similar conditions to help ensure an accurate analysis of any contamination at a selected ground site.

In addition to extracting soil gas samples, extracting both actual soil samples and actual water samples from a selected ground site by any known conventional means is often helpful as well. From the testing of such extracted soil and water samples, additional information can be gleaned. Such additional information may include, for example, the detected presence, the species identification, and the population size of any microbial population present at the selected ground site. Such additional information is often useful in both further helping to determine the extent of any contamination and further helping to delimit any specific area of contamination at the selected ground site.

As partly illustrated in FIG. 1 and as fully illustrated in FIG. 3, monitoring wells 30A through 30M are interspersedly installed to thereby systematically “pigeonhole” the selected ground site 36A. In this way, as soil gas samples are extracted from the interspersed underground soil locations associated with the monitoring wells 30A through 30M, analysis and comparison of the soil gas samples will eventually enable one to both determine the extent of any contamination and delimit any specific area of contamination at the selected ground site 36A. Thus, in the example of the convenience store and gas station site particularly depicted in FIG. 3, soil gas samples from the monitoring wells 30A through 30M have been used to both detect and delimit a specific area of contamination 102A at the selected ground site 36A.

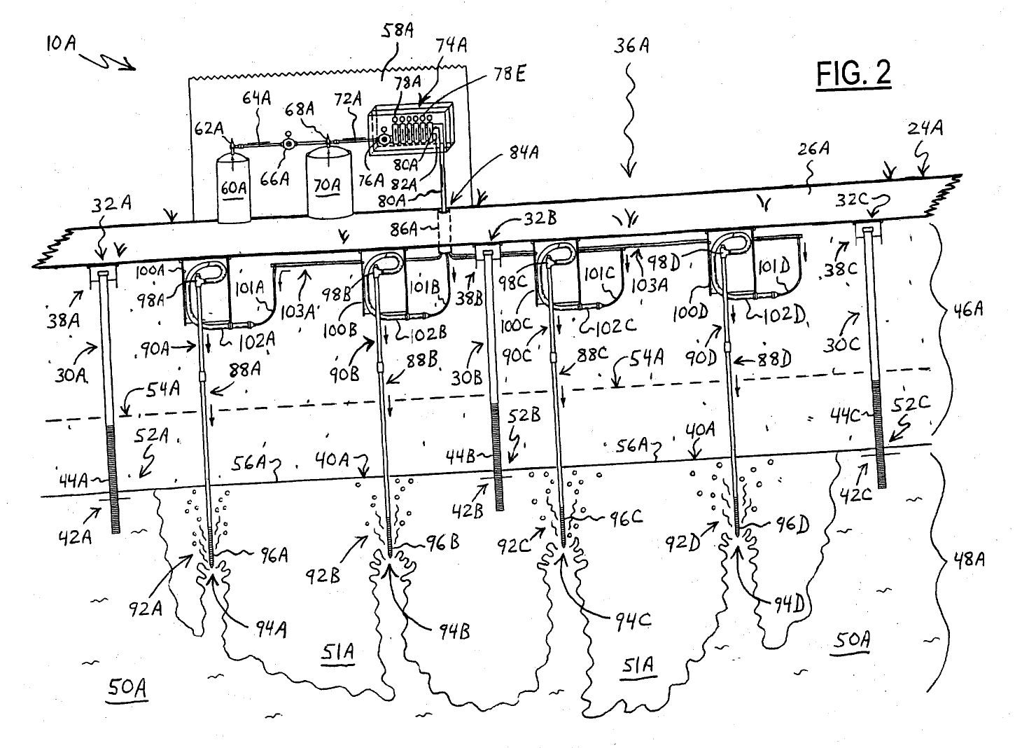

Once the specific area of contamination 102A is detected, a multiplicity of groundwater injection points 94A through 94AD is then set up within the groundwater 51A of the specific area of contamination 102A and the fringe thereof. It is through these groundwater injection points that a determined preselected oxidant or oxygen-releasing agent solution will be injected into the contaminated groundwater 51A to thereby help clean up and remediate the contaminated groundwater 51A. As partly illustrated in FIG. 2 and as fully illustrated in FIG. 3, the groundwater injection points 94A through 94AD, by design, are staggered and somewhat evenly spaced apart within the specific area of contamination 102A. Most preferably, however, the groundwater injection points are arranged in a substantially horizontal and grid-like array fashion within the groundwater 51A of the specific area of contamination 102A.

In general, the purpose of arranging groundwater injection points in a grid-array fashion is to thereby evenly distribute and increase the level of the determined preselected oxidant solution in both the groundwater and its capillary fringe of a determined specific area of contamination. Maintaining an evenly distributed injection flow of the oxidant solution within the contaminated groundwater helps ensure that all of the specific area of contamination will be treated and that as the contaminated groundwater migrates through the aquifer, it will not move out of a treatment zone prior to having its contaminant level successfully reduced to below a desired contaminant target level. It is to be understood, however, that a grid-array arrangement of groundwater injection points may not always be entirely possible, for surface features (for example, trees, buildings, roads, or utilities) present at the selected ground site may dictate that a grid-array arrangement is impossible to fully implement. In such a case, a grid-array arrangement should be adhered to as best as is feasibly possible. Within such a grid-array arrangement, care should be taken to ensure that each groundwater injection point is not situated directly up gradient from a proximate groundwater injection point situated down gradient. With regard to the spacing between the individual groundwater injection points in a grid-array arrangement, a preferred “rule of thumb” is to utilize a known local groundwater flow rate determined over a recent two-month period to determine the appropriate spacing between the groundwater injection points. For example, if local groundwater has been conventionally calculated to migrate at a rate of 120 feet per year at a selected ground site, the recommended spacing between the individual groundwater injection points at that selected ground site would then be 20 feet, since a migration rate of 120 feet per year translates into a migration rate of 10 feet per month or 20 feet every two months. Given such, however, experience has demonstrated that individual groundwater injection points should generally never be spaced apart by fewer than 10 feet. In sum, therefore, the general overall shape, the total space, and the local groundwater migration characteristics of a delimited specific area of contamination at a selected ground site will generally dictate how a grid-array of groundwater injection points will be arranged and spaced therein, thereby ultimately dictating the appropriate number of groundwater injection points to be included within the groundwater of the specific area of contamination.

With regard to depth, the groundwater injection points should generally be suspended within the contaminated groundwater so that the depth of each injection point is such that the determined preselected oxidant solution flowing therefrom is generally being emitted at the middle section of the vertical profile of the contaminated groundwater. For example, if conventional vertical profiling of a particular body of contaminated groundwater has determined that the contamination extends 20 feet below the groundwater surface level, then groundwater injection points should preferably be suspended within the contaminated groundwater so that the oxidant solution exits the groundwater injection points at approximately 6.5 feet below the groundwater surface level, that is, approximately one-third of the way down through the vertical profile of the body of contaminated groundwater. If, as another example, vertical profiling of another body of contaminated groundwater has determined that the contamination extends only 10 feet below the groundwater surface level, then groundwater injection points should preferably be suspended within the contaminated groundwater so that the oxidant solution exits the groundwater injection points at approximately 3.5 feet below the groundwater surface level. If, however, a vertical profile of a particular body of contaminated groundwater is not available, it is then recommended that the groundwater injection points be suspended within the contaminated groundwater at approximately 3.5 feet below the groundwater surface level. Such is recommended because experience has demonstrated that most bodies of contaminated groundwater do not have a vertical profile greater (or thicker) than 10 feet. In most situations, however, it is highly recommended that a vertical profile of a given body of contaminated water be obtained so that groundwater injection points can be suspended at a proper depth, thereby facilitating optimal groundwater remediation performance.

Actual physical implementation of groundwater injection points 94A, 94B, 94C, and 94D from FIG. 3 is particularly illustrated in FIG. 2. As depicted in FIG. 2, the groundwater injection point 94A, for example, is particularly implemented with an injection pipe 88A that is situated, in a substantially vertical fashion, within the vadose zone 46A of the ground 24A. The injection pipe 88A includes both an upper end portion 90A and a lower end portion 92A. The upper end portion 90A of the injection pipe 88A is situated such that its top end both extends upward into a subsurface vault 100A and terminates approximately one foot below the surface 26A of the selected ground site 36A. The lower end portion 92A of the injection pipe 88A, on the other hand, protrudes down below the water table 40A and into the body of contaminated groundwater 51A. The injection pipe 88A itself may, for example, be made of ½-inch schedule 80 PVC pipe. In such a case, the bottom foot of the PVC pipe may be hand cut with a hacksaw, for example, prior to installation such that approximately 8 to 12 cuts are inflicted upon the bottom foot of the PVC pipe. The cuts should extend into the PVC pipe at a depth of approximately one-third the diameter of the PVC pipe. In doing such, a one-foot screen portion 96A is thereby defined on the lower end portion 92A of the injection pipe 88A. In this way, when the injection pipe 88A is properly installed within the ground 24A as depicted in FIG. 2, the screen portion 96A provides an alternate route for an oxidant solution to be injected into the contaminated groundwater 51A should the bottom hole of the injection pipe 88A become plugged with contaminants from the groundwater 51A. In general, the groundwater injection points 94B, 94C, and 94D in FIG. 2 as well as all of the other groundwater injection points 94E through 94AD depicted in FIG. 3 may similarly be implemented.

As an aside, the injection pipes 88A, 88B, 88C, and 88D used for specifically implementing the groundwater injection points 94A, 94B, 94C, and 94D in FIG. 2 may generally be physically installed by one of three preferred methods. These three methods include (1) the hollow-stem or hand auger method, (2) the GeoProbe™ method, and (3) the air jet injection method. In the first method, groundwater injection points are installed by either a hollow-stem auger or by a hand auger. This method is most suitable for selected ground sites that have interbedded layers of sands, silts, or clays with semi-isolated seams and lenses that are hydraulically connected and impacted. In this method, the auger is advanced into the ground until it reaches approximately one-third of the way down through the vertical profile of the body of contaminated groundwater. The soil conditions at the selected ground site should dictate whether a hand auger or a hollow-stem auger is utilized. A hollow-stem auger, for example, is recommended if saturated soil conditions exist such that it is anticipated that any bore hole created within the ground will not stay open long enough for a groundwater injection point to be implemented therein or if the required boring depth for properly suspending a groundwater injection point within the contaminated groundwater is too deep to be accomplished with a hand auger. Regardless of whether a hollow-stem auger or a hand auger is utilized, care should be taken to ensure that cross-contamination of previously uncontaminated seams or lenses does not occur by inadvertently boring through these zones. Once a bore hole has been advanced into the ground to a desired depth with an auger, well screen sand should be poured into the bore hole so that the bottom foot of the bore hole is filled with the well screen sand. Once the well screen sand is in place, a ½-inch schedule 80 PVC pipe should be inserted into the bore hole so that the bottom of the PVC pipe is firmly entrenched within the one foot of well screen sand at the bottom of the bore hole. Prior to actually inserting the PVC pipe into the bore hole, however, the bottom foot (or 12 inches) of the PVC pipe, as briefly alluded to hereinabove, is preferably hand cut with a hacksaw or other similar device to thereby define a screen portion along the bottom foot of the PVC pipe. Once the PVC pipe is ultimately installed, the bore hole should be backfilled with the same well screen sand up to two feet below the water table. Then, from two feet below the water table up to the water table itself, a plug of bentonite (a type of porous clay) should be installed within the bore hole about the PVC pipe. The purpose of this bentonite plug is to prevent any oxidant solution passing down through the PVC pipe during injection from inadvertently migrating straight up through the well screen sand pack into the bore hole about the PVC pipe. Thus, the bentonite plug serves to ensure that any oxidant solution being injected through the bottom screen portion of the PVC pipe will be forced out into the body of contaminated groundwater. The remaining upper portion of the bore hole surrounding the PVC pipe can be backfilled with either cuttings or bentonite chip as preferred, for example, by any geologist or engineer that happens to be onsite. When properly installed in this manner, the top end of the PVC pipe preferably remains situated about one foot below the surface of the selected ground site, thereby standing ready to receive an oxidant solution for injection into the contaminated groundwater.

The second preferred method for installing injection pipes or tubes used for implementing groundwater injection points is the GeoProbe™ method. (GeoProbe™ is a trademark of KEJR Engineering Incorporated located within the state of Kansas.) This method is best suited for selected ground sites where the soil is sandy and where the vertical profile of the contaminated groundwater extends to a depth of greater than 20 feet below the surface of the selected ground site. In this method, a GeoProbe™ apparatus is utilized to advance a 6-inch stainless steel well screen down to a required depth. The stainless steel well screen itself is specifically designed for compatibility with the GeoProbe™ apparatus. According to the method, an expendable drive point is placed on the bottom of the drive rod of the GeoProbe™ apparatus. The drive point is slightly larger in diameter than the drive rod and is specifically held in place on the bottom of the drive rod by a rubber gasket. The inside of the expendable drive point has a female thread which is specifically designed to accept the male thread of the aforementioned 6-inch stainless steel well screen. Once the drive point is advanced down to the required depth within the aquifer by the drive rod, a polypropylene tube is then connected to the stainless steel well screen and inserted down the center of the drive rod. The stainless steel well screen and the polypropylene tube are then twisted to connect the threads of the well screen to the threads of the expendable drive point. Once they are successfully connected, the drive rod is suddenly pulled back up, thereby causing the expendable drive point to pop off the bottom of the drive rod. As a result, the point along with both the well screen and one open end of the polypropylene tube are left to remain in place within the aquifer at the desired depth. In this way, the other open end of the polypropylene tube extending up to the surface of the selected ground site stands ready to receive an oxidant solution for injection into the contaminated groundwater of the aquifer.

The third preferred method for installing injection pipes used for implementing groundwater injection points is the air jet injection method. In this method, an air compressor is utilized to advance a ½-inch schedule 80 PVC pipe through the ground and into contaminated groundwater within the aquifer. This method is best suited for selected ground sites where the soil is sandy and is without clay lenses and seams or large cobbles. This method, however, is not recommended for reaching depths of greater than 20 feet below the ground surface. Although such depths may possibly be reached with this method, the probability of success with this method diminishes significantly beyond 20 feet. Prior to installation, the PVC pipe itself should be cut and prepared as described hereinabove with regard to the auger method, thereby defining a screen portion on the lower bottom foot of the PVC pipe. An air compressor selected to be utilized in this method should be of sufficient capacity to operate on the order of about 185 cubic feet per minute (cf/m) at about 115 pounds per square inch (psi). The discharge hose of the selected air compressor should be connected via a series of hose clamps to the top end of the PVC pipe. In this way, when the air compressor is turned on, air exiting the bottom of the PVC pipe will act like a cutting tool, thereby enabling the advancement of the PVC pipe into the ground. Once the PVC pipe is advanced to its desired depth, the air compressor can then be turned off and the top end of the PVC pipe can be cut to one foot below grade, thereby standing ready to receive an oxidant solution for injection into the contaminated groundwater. In general, the air jet injection method is oftentimes the method of choice, for experience has demonstrated that as many as eighty groundwater injection points or more can be installed within a single day at a selected ground site with minimal site disruption.

In order to deliver a determined preselected oxidant or oxygen-releasing agent solution to all of the groundwater injection points 94A through 94AD in both FIG. 2 and FIG. 3, a first tank 60A containing a substantially inert gas under pressure and a second tank 70A containing a preselected oxidant or oxygen-releasing agent are provided as depicted in FIG. 2. The first tank 60A, in particular, preferably contains compressed air or some other similar inert gas under pressure, such as, for example, nitrogen. The second tank 70A, on the other hand, preferably contains hydrogen peroxide as a preselected oxidant or oxygen-releasing agent of choice.

Although other oxidants or oxygen-releasing agents or compounds may instead be utilized in the system 10A according to the present invention, experimentation has uniquely demonstrated that injecting a hydrogen peroxide solution into contaminated groundwater can increase the dissolved oxygen concentration level therein to as high as 100 parts per million (ppm). Such is true even under tight soil conditions where, for example, clay is present within the soil. By way of explanation, the injection of a hydrogen peroxide solution into the aquifer gives rise to a natural concentration gradient therein that effectively drives the solution to diffuse downward into deep soil pores where contaminants are apt to be sequestered. Due to the natural and inherent compositional make-up of hydrogen peroxide, a hydrogen peroxide solution is uniquely capable of diffusing into tight soil layers whereas pure oxygen solutions, which are commonly utilized in many other modern remediation systems, are not able to effectively penetrate such tight soil layers. As a result, the marked increase in dissolved oxygen concentrations produced in deep soil layers through the utilization of a hydrogen peroxide solution, even under tight soil conditions, greatly facilitates both chemical oxidation remediation and bioremediation of groundwater contaminants. Furthermore, from a geochemical standpoint, injecting a hydrogen peroxide solution into the ground soil is not as harsh as many other modern groundwater remediation techniques and is instead very mild in terms of pH value. In view of such, hydrogen peroxide, as previously indicated, is therefore the preferred oxidant or oxygen-releasing agent of choice for use in the system 10A according to the present invention.

Further, in FIG. 2, a pressure conduit 64A along with a pressure regulator 66A are interposed between the first tank 60A and the second tank 70A to thereby provide pressure-regulated fluid communication between the first tank 60A and the second tank 70A. The first tank 60A has an associated shut-off valve 62A, and the second tank 70A has an associated shut-off valve 68A as well. The shut-off valves 62A and 68A help facilitate both the removal and the replacement of the first tank 60A and the second tank 70A whenever their contents become periodically exhausted. In addition to being coupled to the pressure regulator 66A, the second tank 70A is also coupled via another pressure conduit 72A to another pressure regulator 76A. This pressure regulator 76A, as illustrated in FIG. 2, is housed within a control panel 74A which itself is mounted, for example, on a wall, fence 58A, or other structure. The pressure conduit 72A and the pressure regulator 76A together help provide pressure-regulated fluid communication between the second tank 70A and a header pipe 82A also situated within the control panel 74A. The header pipe 82A, in turn, is connected to a multiplicity of flow meters 78A through 78AD (only flow meters 78A through 78F are shown in FIG. 2) that are matchingly congruent in number to the multiplicity of groundwater injection points 94A through 94AD implemented within the contaminated groundwater 51A. The flow meters 78A through 78AD serve to regulate fluid flow between the header pipe 82A and a multiplicity of individual injection conduits 101A through 101AD (not specifically shown within the control panel 74A) that are harnessed together and collectively pass through a main outlet pipe 80A. The main outlet pipe 80A and the individual injection conduits together exit the control panel 74A and enter the ground 24A via a ground bore 84A.

Once within the ground 24A, the individual injection conduits 101A through 101AD exit the main outlet pipe 80A, collectively pass down through a ground conduit 86A, and then laterally disperse at approximately one foot underground. The individual injection conduits are generally situated and extended alongside each other underground, thereby defining a horizontal underground tubing network 103A that itself extends through a network of ground tunnels. Such an underground tubing network 103A is partly shown in FIG. 2 but is particularly highlighted in FIG. 3. The individual injection conduits that comprise the underground tubing network 103A are preferably made of polypropylene tubing. Via this underground tubing network 103A, the individual injection conduits 101A through 101AD ultimately reach and are matched with the upper end portions 90A through 90AD of the injection pipes 88A through 88AD. The individual injection conduits, as illustrated in FIG. 2, can particularly be connected to the tops of the upper end portions of the injection pipes by means of hoses 102A through 102AD and coupling joints 98A through 98AD. As a simple alternative, however, the individual injection conduits may instead be more directly connected to the tops of the upper end portions of the injection pipes with simple compression fittings. In such a configuration as described hereinabove, fluid communication is thereby ultimately established between the second tank 70A containing the preselected oxidant and the multiplicity of groundwater injection points 94A through 94AD suspended within the contaminated groundwater 51A situated beneath the selected ground site 36A.

During operation of the system 10A, the first tank 60A introduces its contents into the top of the second tank 70A at a preferred delivery pressure ranging, for example, from 25 to 75 pounds per square inch (psi). This delivery pressure can be carefully regulated, monitored, maintained, and adjusted with the pressure regulator 64A. As the contents of the first tank 60A are introduced into the second tank 70A in this manner, the second tank 70A thereby becomes pressurized. To accommodate such a delivery pressure, the second tank 70A must preferably be able to withstand pressures of up to 200 psi. Within such a pressurized environment, the preselected oxidant initially contained within the second tank 70A is thereby withdrawn under pressure in solution form and communicated into the pressure conduit 72A. The pressure conduit 72A and the pressure regulator 76A together, in turn, further communicate the preselected oxidant solution into the header pipe 82A within the control panel 74A. Once within the header pipe 82A, the flow meters 78A through 78AD regulate and inject the preselected oxidant solution into the multiplicity of individual injection conduits harnessed together within the main outlet pipe 80A. The individual injection conduits 101A through 101AD then direct the preselected oxidant solution, by way of both the ground conduit 86A and the underground tubing network 103A, into the upper end portions 90A through 90AD of the injection pipes 88A through 88AD. Once within the injection pipes 88A through 88AD, the preselected oxidant solution is then communicated down to the lower end portions 92A through 92AD of the injection pipes where the preselected oxidant solution is emitted under pressure through the screen portions 96A through 96AD of the injection pipes. In this way, the preselected oxidant solution is successfully injected into the contaminated groundwater 51A by the system 10A according to the present invention.

According to the present invention, a first primary purpose of injecting the preselected oxidant hydrogen peroxide into contaminated groundwater is to thereby facilitate direct “chemical oxidation remediation” of the contaminated groundwater. A second primary purpose is to also thereby increase the dissolved oxygen concentration level within the contaminated groundwater. In doing so, ample oxygen is then provided to enable local underground bacteria to both live and thrive. Increased bacteria populations resulting therefrom are then able to quickly act upon the contaminants within the groundwater, thereby facilitating “bioremediation” of the contaminated groundwater as well. Like humans, however, bacteria neither thrive in oxygen-deficient environments nor like oxygen-rich environments. In light of such, the system 10A according to the present invention should preferably be operated to carefully maintain an oxygen concentration level of between, for example, 15% to 25% within the vadose zone 46A above the contaminated groundwater 51A being treated. Such can be accomplished by first extracting and testing soil gas samples from monitoring wells situated within the specific area of contamination 102A. Based upon information gleaned from the soil gas samples, the concentration of hydrogen peroxide within the preselected oxidant solution and/or the injection flow rate of the preselected oxidant solution can then be adjusted as deemed appropriate. Such adjusting can primarily be done by altering the contents of the second tank 70A and/or by readjusting the setting on the pressure regulator 66A so that the system-driving delivery pressure originating from the first tank 60A is correspondingly properly adjusted. For example, if extracted soil gas samples indicate that the dissolved oxygen concentration has fallen below 15% within the vadose zone 46A just above contaminated groundwater 51A that is being treated with hydrogen peroxide solution injections, then the delivery pressure should be readjusted higher. In this way, the injection flow rate of the hydrogen peroxide solution is correspondingly increased to thereby attain a dissolved oxygen concentration of between 15% and 25%. If, on the other hand, extracted soil gas samples indicate that the dissolved oxygen concentration exceeds 25% within the vadose zone 46A just above contaminated groundwater 51A that is receiving treatment, then the injection flow rate of the hydrogen peroxide solution should be decreased to thereby attain a dissolved oxygen concentration of between 15% and 25%. For further system precision, water samples extracted by conventional means from the contaminated groundwater 51A can also be studied to help accurately determine dissolved oxygen concentration levels. Depending on both specific soil conditions and specific system goals, it is to be understood that target oxygen concentration ranges other than 15% to 25% may indeed be adopted and utilized with the system according to the present invention.

With regard to system performance monitoring, before even initiating the injection of the hydrogen peroxide solution into contaminated groundwater 51A, it is most preferred that a “baseline” first be established before the system 10A is put into full operation. In particular, it is recommended that extracted soil gas samples, actual soil samples, and even water samples be initially collected to determine the extent of contamination at the selected ground site 36A in order to initially help determine an appropriate hydrogen peroxide solution concentration and an appropriate injection flow rate for initial use in the system 10A. Then, once the injection of hydrogen peroxide solution into the contaminated groundwater 51A is commenced by the system 10A, it is thereafter recommended that samples be collected once per week for the first month to thereby help monitor the performance and effectiveness of the system 10A. After the first month, samples collected for monitoring the system 10A need only be collected once per month for the next two months and then quarterly thereafter. Experience has demonstrated that when testing the collected samples, an increase in the carbon dioxide concentration level within the contaminated groundwater 51A can generally be anticipated within the first month. Such an increase in the carbon dioxide concentration level is the result of increased contaminant degradation due to the concerted action of both chemical oxidation remediation and bioremediation working within the system 10A.

Regarding supply of the preselected oxidant hydrogen peroxide, hydrogen peroxide for the system 10A can be properly supplied by any number of industrial chemical supply companies. Depending on system size and system hydrogen peroxide requirements at a selected ground site, different sized tanks for containing the hydrogen peroxide may be utilized within the system, and the number of tanks that can be accommodated by the control panel at the same time can be adjusted as well. A preferred size for a hydrogen peroxide tank is one that necessitates that the tank be refilled no more frequently than once per month. The concentration of the hydrogen peroxide within the tank can also be selectively varied so that higher concentrations would require a reduced hydrogen peroxide injection flow rate within the system to deliver the same amount of hydrogen peroxide. For example, a tank with a 2% concentration of hydrogen peroxide would provide the same number of hydrogen peroxide molecules within the system as a tank with a 1% concentration of hydrogen peroxide would at twice the delivery pressure. When the hydrogen peroxide within the tank is eventually exhausted, the control panel should then be shut off and the pressure within the tank should thereafter be relieved. Once tank pressure has been relieved down to a level that is equivalent to surrounding atmospheric pressure, the tank can then be opened so that a new supply of hydrogen peroxide can be introduced into the tank in appropriate concentration. Once the tank is full, the tank should be closed in an airtight manner and re-pressurized back up to an appropriate pressure. Thereafter, the control panel can be turned back on so that the system can resume hydrogen peroxide injection into the contaminated groundwater at the selected ground site. Assuming the pressure regulator 66A is at an appropriate setting, the system 10A automatically recalibrates itself as it resumes its work.

As the system 10A operates over time, the injection flow rate of the hydrogen peroxide solution will need to be adjusted down from time to time. Such is due to the fact that the system will need only inject progressively smaller amounts of hydrogen peroxide solution into the groundwater as contamination within the groundwater diminishes over the treatment period. As mentioned previously hereinabove, extracted soil gas samples can be utilized to closely monitor and evaluate the overall performance of the system 10A. Once such extracted soil gas samples, along with possibly actual soil samples and/or water samples, conclusively indicate that groundwater contamination has been largely eliminated and that the system 10A no longer needs to continue operating, the system 10A can then be abandoned in place. In particular, the system 10A can be abandoned in place by simply pumping a bentonite/cement mixture through the control panel 74A, down through the injection pipes 88A through 88AD, and into the groundwater injection points 94A through 94AD. This will effectively seal the system 10A and thereby prevent any future surface migration of contamination up through the system 10A to the surface 26A of the ground 24A. The control panel 74A itself can be dismantled and reused at another selected ground site.

In summary, there are several advantages to utilizing the system according to the present invention instead of other known conventional remediation systems. As a first advantage, the system is designed to self-regulate. That is, if pressure from a chemical oxidation reaction within the contaminated groundwater at a given number of groundwater injection points exceeds the regulated delivery pressure that drives the hydrogen peroxide solution through those same groundwater injection points, then injection of the hydrogen peroxide solution through those same groundwater injection points will automatically cease. In contrast, however, injection of the hydrogen peroxide solution will continue at any other groundwater injection points where the regulated delivery pressure driving the hydrogen peroxide solution is not sufficiently counteracted by a chemical oxidation reaction within the contaminated groundwater. Once a chemical oxidation reaction subsides to the point that its associated counteracting pressure exerted on a given groundwater injection point slips below the regulated delivery pressure that drives the hydrogen peroxide solution, the flow of hydrogen peroxide solution through that same groundwater injection point will resume as before.

In addition to its ability to self-regulate, the system also advantageously successfully treats contaminated groundwater while underground and significantly increases dissolved oxygen concentrations within contaminated groundwater. Experience has uniquely demonstrated that the system is particularly more effective than other currently known groundwater remediation systems in delivering high concentrations of dissolved oxygen to contaminated groundwater, even in tight soil conditions, when hydrogen peroxide is specifically utilized as the preselected oxidant or oxygen-releasing agent within the system. Furthermore, the system advantageously requires minimal human supervision during operation, requires no electricity or electrical equipment for successful operation, requires no mechanical parts that are prone to breaking or requiring unintended maintenance, and is relatively inexpensive. As a final listed advantage, the system according to the present invention only causes minimal site disruption and does not interfere with underground utilities in suburban settings. Such an advantage is particularly highlighted in FIG. 3 wherein the system 10A has been installed at the selected ground site 36A. The selected ground site 36A itself includes a convenience store 104A, three gas pump dispenser islands 120A through 120C, a large gas pump dispenser island canopy 118A, an above-ground storage tank (AST) 106A, two underground storage tanks (USTs) 108A and 108B, an underground fuel communication network 122A, three sidewalks 112A through 112C, two roads 110A and 110B, six sections of lawn grass 114A through 114F, and a large section of asphalt 116A. As clearly illustrated in FIG. 3, the system 10A nicely accommodates all structural features at the selected ground site 36A.

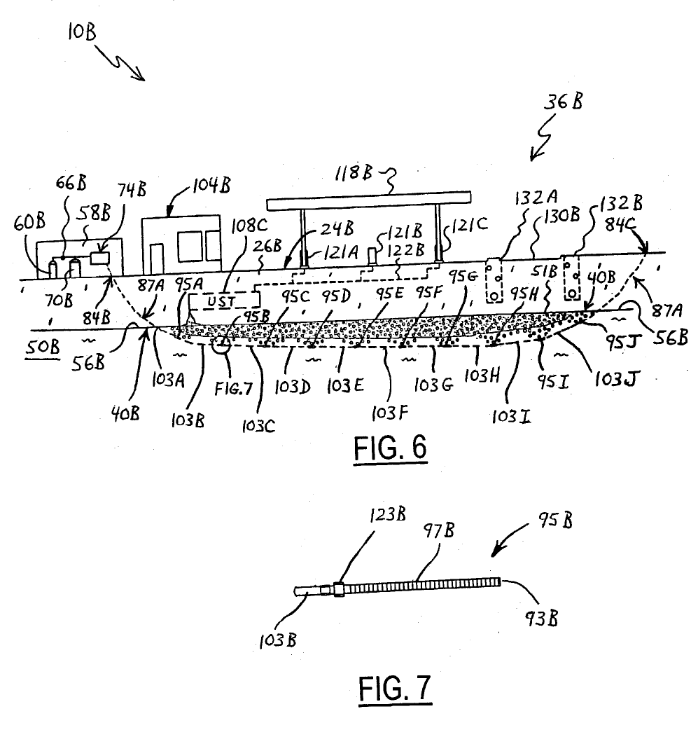

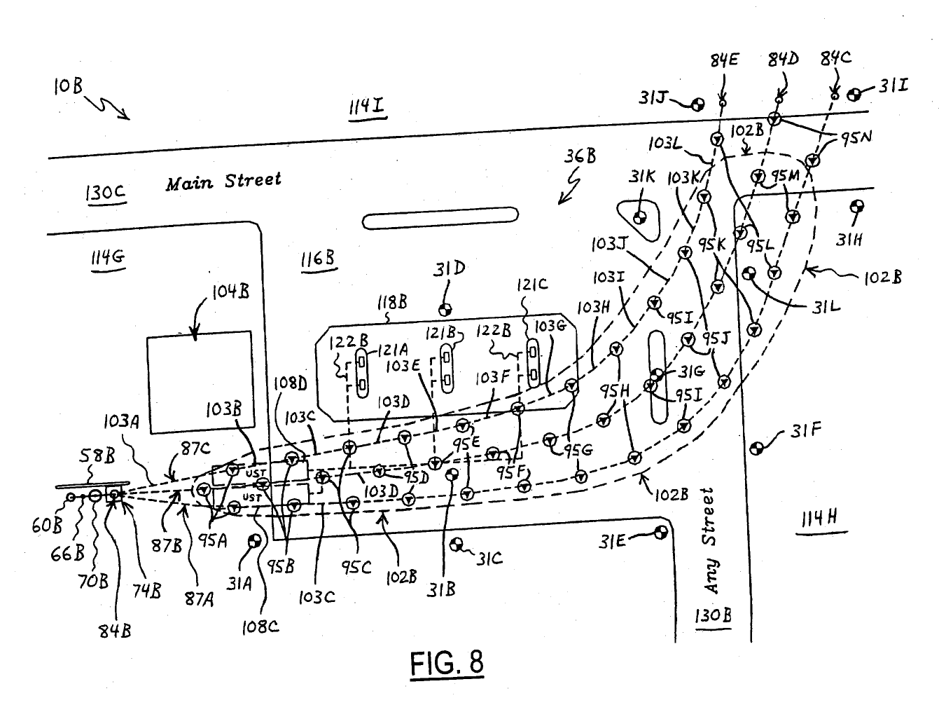

In FIGS. 4 through 8, another embodiment of a system 10B for the self-regulated remediation of contaminated groundwater 51B situated beneath the surface 26B of a selected ground site 36B is illustrated. As shown in both FIG. 6 and FIG. 8, the ground site 36B in this second embodiment is particularly a simple gas station site. The ground site 36B has been selected in order to be tested for potential contamination. Monitoring wells 31A through 31L, as depicted in FIG. 8, are utilized to both determine the extent of contamination and delimit the specific area of contamination 102B at the selected ground site 36B.

In order to deliver a determined preselected oxidant solution to all of the groundwater injection points 95A through 95N depicted in FIG. 4, FIG. 6, and FIG. 8, a first tank 60B containing a substantially inert gas under pressure and a second tank 70B containing a preselected oxidant are provided as depicted in FIG. 4. The first tank 60B, in particular, preferably contains compressed air or some other similar inert gas under pressure, such as, for example, nitrogen. The second tank 70B, on the other hand, preferably contains hydrogen peroxide as a preselected oxidant of choice. A pressure conduit 64B along with a pressure regulator 66B are interposed between the first tank 60B and the second tank 70B to thereby provide pressure-regulated fluid communication between the first tank 60B and the second tank 70B. The first tank 60B has an associated shut-off valve 62B, and the second tank 70B has an associated shut-off valve 68B as well. In addition to being coupled to the pressure regulator 66B, the second tank 70B is also coupled via another pressure conduit 72B to another pressure regulator 76B. This pressure regulator 76B is housed within a control panel 74B which itself is mounted on a fence 58B. The pressure conduit 72B and the pressure regulator 76B together help provide pressure-regulated fluid communication between the second tank 70B and a header pipe 82B also situated within the control panel 74B. The header pipe 82B, in turn, is connected to a multiplicity of flow meters 79A through 79AN (only flow meters 79A through 79F are shown in FIG. 4) that are matchingly congruent in number to the multiplicity of groundwater injection points 95A through 95N implemented within the contaminated groundwater 51B below the groundwater surface level 56B which coincides with the water table 40B. The flow meters 79A through 79AN serve to regulate fluid flow between the header pipe 82B and a multiplicity of individual injection conduits 103A through 103AN (not specifically shown within the control panel 74B) that are harnessed together and collectively pass through a main outlet pipe 80B. The main outlet pipe 80B and the individual injection conduits together exit the control panel 74B and enter the ground 24B via a ground bore 84B.

Once within the ground 24B, the individual injection conduits 103A through 103AN exit the main outlet pipe 80B where they are then separated into three separate bunches. As illustrated in FIG. 8, each separate bunch of individual injection conduits passes through one of three separate underground bore tunnels 87A through 87C. As illustrated in both FIG. 6 and FIG. 8, the three underground bore tunnels 87A through 87C are purposely defined within the ground 24B such that the bore tunnels extend from the ground bore 84B, cross below the water table 40B, specifically pass under the body of contaminated groundwater 511B, cross back over the water table 40B, and terminate at three separate ground bores 84C through 84E. Within the underground bore tunnel 87A, for example, the free end portions of the individual injection conduits passing therethrough are each pre-cut so that all individual injection conduits within the underground bore tunnel 87A have different lengths. Such is particularly illustrated, by way of example, in both FIG. 4 and FIG. 5, wherein the three individual injection conduits 103A through 103C are each depicted as having a different length. In FIG. 4, the individual injection conduits 103A through 103C are fully extended and commonly situated alongside each other within the underground bore tunnel 87A. In FIG. 5, the individual injection conduits 103A through 103C are each individually illustrated within the underground bore tunnel 87A for purposes of clarity and understanding herein. As illustrated in both FIG. 5 and FIG. 7, the individual injection conduit 103B, by way of example, is preferably comprised of polypropylene tubing and includes an expandable screen portion 97B that is attached to its free end portion 93B with a compression fitting 123B. Given such a construction, a groundwater injection point 95B is thereby defined on the free end portion 93B of the individual injection conduit 103B. All other individual injection conduits are similarly constructed. In this way, a substantially evenly-spaced series of groundwater injection points, beginning with groundwater injection point 95A, is successfully situated within each of the three underground bore tunnels 87A through 87C. As a result, when a hydrogen peroxide solution is injected into the uncontaminated groundwater 50B just below the body of contaminated groundwater 51B via the groundwater injection points, the contaminated groundwater 51B is thereby completely and evenly treated.

The underground bore tunnels depicted in this second embodiment of the present invention are preferably created with a “horizontal directional drilling technique.” This particular technique is best utilized at selected ground sites that have more permeable soils and that are without interbedded clay or silt layers. Because of the wide drilling radius and significant depth needed to best carry out this technique, the technique may not be suitable for smaller sites with limited access. In this technique, a horizontal directional drill rig is utilized to create and extend an underground bore tunnel along a predetermined path that generally extends along the axis of the body of contaminated water just beneath or just along the bottom thereof. Modern horizontal drilling techniques enable the underground bore tunnel to be “steered” in the direction and depth desired by a designer. Once the underground bore tunnel is completed and the drill stem has fully exited the ground at a predetermined location on the far end of the bore tunnel, a series of pre-cut polypropylene tubes are then connected to the drill stem and pulled back through the underground bore tunnel, thereby eventually exiting the bore tunnel at the point where the bore tunnel was first initiated. The pre-cut polypropylene tubes that are pulled through the bore tunnel are preferably pre-cut to different lengths so that each successive polypropylene tube is slightly longer than the next. The goal of this technique is to extend and situate a series of polypropylene tubes alongside each other within the ground so that the free ends of the tubes terminate at different locations within the bore tunnel underneath the body of contaminated groundwater. In this way, as a hydrogen peroxide solution is then pumped from aboveground into each one of these polypropylene tubes, the hydrogen peroxide solution emitted from the free ends of the tubes is thereby evenly applied to the body of contaminated groundwater. In accordance with the technique, the number of underground bore tunnels and the number of individual groundwater injection points and tubes installed in each bore tunnel can generally be varied as desired. The goal in varying underground bore tunnel networks is to determine a way to thereby situate groundwater injection points into a grid-array pattern underneath the body of contaminated groundwater at a selected ground site. Caution, however, should be taken when installing a system according to the present invention through use of the horizontal directional drilling technique. Utility corridors and other subsurface features may be present within the soil at the selected ground site. In light of such, such corridors and/or features must be identified prior to drilling. At selected ground sites where unidentified underground storage tanks (UST) are particularly suspected to be present, ground-penetrating radar should be utilized to “clear” any proposed bore tunnel path prior to commencement of drilling.

In summary, as was the case of the system 10A in the embodiment illustrated in FIGS. 1 through 3 according to the present invention, the system 10B in the embodiment illustrated in FIGS. 4 through 8 according to the present invention also has the advantages of being able to self-regulate, successfully treat contaminated groundwater while underground, significantly increase dissolved oxygen concentrations within contaminated groundwater even in tight soil conditions, operate with minimal human supervision, operate with no electricity or electrical equipment, operate with no mechanical parts that are prone to breaking or requiring unintended maintenance, and be cost effective. As a final listed advantage, the system 10B according to the present invention likewise only causes minimal site disruption and does not interfere with underground utilities in suburban settings. Such an advantage is particularly highlighted in both FIG. 6 and FIG. 8 wherein the system 10B has been installed at the selected ground site 36B. The selected ground site 36B itself includes a gas station cashier building 104B, three gas pump dispenser islands 121A through 121C, a large gas pump dispenser island canopy 118B, two underground storage tanks (USTs) 108C and 108D, an underground fuel communication network 122B, two streets 130B and 130C, streetside underground utility corridors 132A and 132B, three sections of lawn grass 114G through 114I, and a large section of asphalt 116B. As clearly illustrated in both FIG. 6 and in FIG. 8, the system 10B nicely accommodates all structural features at the selected ground site 36B.

While the present invention has been described in what are presently considered to be its most practical and preferred embodiments and/or implementations, it is to be understood that the invention is not to be limited to the disclosed embodiments. On the contrary, the present invention is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A process for the self-regulated remediation of groundwater situated beneath the surface of a contaminated ground site, said self-regulated groundwater remediation process comprising the steps of:
selecting a ground site to be tested for potential contamination;
extracting soil gas samples from interspersed locations within an underground soil layer disposed above the surface level of groundwater situated beneath the surface of said selected ground site;
gleaning information from said extracted soil gas samples to both determine the extent of any contamination and delimit any specific area of contamination at said selected ground site;
determining both an appropriate concentration of a preselected oxygen-releasing agent within a solution and an appropriate flow rate of injection according to said determined extent of contamination at said selected ground site;
determining both an appropriate number of groundwater injection points and an appropriate spacing between said groundwater injection points according to said delimited specific area of contamination at said selected ground site; and
delivering said determined preselected oxygen-releasing agent solution under pressure into said groundwater within said delimited specific area of contamination at said selected ground site via said groundwater injection points at said determined injection flow rate.

2. The self-regulated groundwater remediation process according to claim 1, wherein said selected ground site includes a gas station.

3. The self-regulated groundwater remediation process according to claim 1, wherein said underground soil layer from which said soil gas samples are extracted is within the vadose zone.

4. The self-regulated groundwater remediation process according to claim 1, wherein said groundwater surface level coincides with the water table beneath said selected ground site.

5. The self-regulated groundwater remediation process according to claim 1, wherein the step of extracting soil gas samples includes the steps of:
installing a plurality of monitoring wells at said selected ground site such that each said monitoring well provides fluid communication between said surface of said selected ground site, said underground soil layer, and said groundwater; and
providing a vacuum pump for each said monitoring well at said selected ground site; and
utilizing each said vacuum pump to create a vacuum within each said monitoring well to thereby draw and obtain said soil gas samples from said interspersed locations within said underground soil layer.

6. The self-regulated groundwater remediation process according to claim 1, said self-regulated groundwater remediation process further comprising the steps of:
extracting soil samples from said selected ground site; and
extracting water samples from said groundwater situated beneath said surface of said selected ground site; and
gleaning additional information from both said extracted soil samples and said extracted water samples to both further help determine the extent of any contamination and further help delimit any specific area of contamination at said selected ground site.

7. The self-regulated groundwater remediation process according to claim 6, wherein said gleaned additional information from both said extracted soil samples and said extracted water samples includes the detected presence, the species identification, and the population size of any microbial population present at said selected ground site.

8. The self-regulated groundwater remediation process according to claim 1, wherein said gleaned information from said extracted soil gas samples includes both the concentration of oxygen and the concentration of carbon dioxide within said underground soil layer.

9. The self-regulated groundwater remediation process according to claim 8, wherein the step of gleaning information from said extracted soil gas samples is accomplished with a soil gas meter.

10. The self-regulated groundwater remediation process according to claim 8, said self-regulated groundwater remediation process further comprising the step of:
regulating both said delivery pressure and said determined injection flow rate of said determined preselected oxidant solution to thereby maintain said oxygen concentration within a range of 15 to 25 percent within said underground soil layer within said delimited specific area of contamination at said selected ground site.

11. The self-regulated groundwater remediation process according to claim 1, wherein said preselected oxygen-releasing agent is hydrogen peroxide.

12. The self-regulated groundwater remediation process according to claim 1, said self-regulated groundwater remediation process further comprising the step of:
arranging said groundwater injection points in a substantially horizontal and grid-like fashion within said groundwater within said delimited specific area of contamination at said selected ground site.

13. The self-regulated groundwater remediation process according to claim 12, said self-regulated groundwater remediation process further comprising the step of:
utilizing a known local groundwater flow rate determined over a recent two-month period to determine said appropriate spacing between said groundwater injection points within said groundwater within said delimited specific area of contamination at said selected ground site.

14. The self-regulated groundwater remediation process according to claim 1, said self-regulated groundwater remediation process further comprising the step of:
utilizing a known vertical profile of said groundwater within said delimited specific area of contamination at said selected ground site to situate said groundwater injection points at approximately one-third of the way down through said known vertical profile of said groundwater within said delimited specific area of contamination at said selected ground site.

15. The self-regulated groundwater remediation process according to claim 1, said self-regulated groundwater remediation process further comprising the step of:
utilizing a pressure regulator to thereby maintain said delivery pressure of said determined preselected oxidant solution within a range of 25 to 75 pounds per square inch.

16. A process for the self-regulated remediation of groundwater situated beneath the surface of a contaminated ground site, said self-regulated groundwater remediation process comprising the steps of:
selecting a ground site to be tested for potential contamination;
extracting soil gas samples from interspersed locations within an underground soil layer disposed above the water table defined by groundwater situated beneath the surface of said selected ground site;
gleaning information from said extracted soil gas samples to both determine the extent of any contamination and delimit any specific area of contamination at said selected ground site;
determining both an appropriate concentration of hydrogen peroxide within a solution and an appropriate flow rate of injection according to said determined extent of contamination at said selected ground site;
determining both an appropriate number of groundwater injection points and an appropriate spacing between said groundwater injection points according to said delimited specific area of contamination at said selected ground site; and
delivering said determined hydrogen peroxide solution under pressure into said groundwater within said delimited specific area of contamination at said selected ground site via said groundwater injection points at said determined injection flow rate.

17. A system for the self-regulated remediation of groundwater situated beneath the surface of a contaminated ground site, said self-regulated groundwater remediation system comprising:
a plurality of monitoring wells installed interspersedly at a selected ground site to be tested for potential contamination, each said monitoring well thereby providing fluid communication between the surface of said selected ground site, groundwater situated beneath said surface of said selected ground site, and an underground soil layer disposed above the surface level of said groundwater;
a matching plurality of vacuum pumps in fluid communication with the surface openings of said monitoring wells at said selected ground site;
a matching plurality of soil gas meters in fluid communication with said surface openings of said monitoring wells at said selected ground site;
a first tank for containing a substantially inert gas under pressure;
a second tank for containing a preselected oxygen-releasing agent;
a pressure regulator interposed between said first tank and said second tank for providing pressure-regulated fluid communication between said first tank and said second tank; and
a multiplicity of groundwater injection points in fluid communication with said second tank and spaced apart within said groundwater within a delimited specific area of contamination at said selected ground site.

18. The self-regulated groundwater remediation system according to claim 17, wherein said substantially inert gas includes air.

19. The self-regulated groundwater remediation system according to claim 17, wherein said preselected oxygen-releasing agent is hydrogen peroxide.

20. The self-regulated groundwater remediation system according to claim 17, wherein said groundwater injection points have a spacing arrangement that is substantially horizontal and grid-like within said groundwater within said delimited specific area of contamination at said selected ground site.
